(19) United States
(12) Patent Application Publication
(10) Pub. No.: US 2014/0122375 A1
(43) Pub. Date: May 1, 2014

(54) PARKING PRICING SYSTEM

(71) Applicants: XEROX CORPORATION, Norwalk, CT (US); PALO ALTO RESEARCH CENTER INCORPORATED, Palo Alto, CA (US)

(72) Inventors: Faming LI, Penfield, NY (US); Haitham Hindi, Menlo Park, CA (US); Daniel H. Greene, Sunnyvale, CA (US); Yu An Sun, Webster, NY (US)

(73) Assignees: Palo Alto Research Center Incorporated, Palo Alto, CA (US); Xerox Corporation, Norwalk, CT (US)

(21) Appl. No.: 13/666,064

(22) Filed: Nov. 1, 2012

(51) Int. Cl. G07B 15/02

(52) U.S. Cl. 705/418

(57) ABSTRACT

A parking pricing with occupancy feedback control for achieving an optimal occupancy level for a parking space area, so that at least one space is available and circling is not necessary. The parking pricing with occupancy feedback control system proposes to implement a market based parking pricing from an occupancy control approach. The parking price system seeks to maintain a desired occupancy level by measuring real-time parking space occupancy and using controller to automatically adjust parking rates to change with real-time demand. Occupancy feedback control is used to adjust parking space pricing so that the occupancy level approaches a target capacity level. Parking space sensors measure the presence of the vehicles, a parking control engine compares the real-time occupancy of the parking spaces to the target occupancy of the parking spaces, and adjusts the parking pricing to regulate the demand, so that the parking space occupancy converges to its target.

### BACKGROUND

Urban parking space is a limited resource that needs to be properly managed. Today most cities have time limited free parking, which usually results in drivers searching for parking when the demand exceeds supply. As drivers search for parking spaces, they waste time, gas, and lead to more traffic congestion and delay.

Two basic strategies for parking space pricing include, non-market based pricing and the other is a market based pricing. Non-market pricing features free or subsidized parking and usually apply time limits in favor of short term parkers. Parking demand that exceeds supply results in the common phenomenon of “circling”—cars going round and round the local area searching for limited, cheap parking, leading to more congestion and delay. A look at several recent studies show that “parking search” traffic accounts for between 30% and 45% of all traffic in dense urban districts. As a result, more and more cities are turning to market based pricing.

More effective parking management strategies are cost based or include pricing measures that link parking rates more directly to demand. One example is a recent pilot program in San Francisco, California called SFpark. In this program, a pre-determined price profile is updated once a month. This pre-determined pricing, however, cannot catch the real-time fluctuation in parking demand. So the desired occupancy level cannot be achieved consistently.

### SUMMARY

The present application relates to a parking price system to achieve an optimal occupancy level for a parking space area, so that space is available and circling is not necessary.

The parking price system of the present application implements a market-based pricing using an occupancy control approach. The pricing system seeks to maintain a desired occupancy level by measuring the current occupancy and then using a processor based controller to automatically set variable parking rates that change with real-time demand.

This parking price system proposes to use a feedback control to adjust the parking pricing so that the occupancy level approaches a target capacity. With parking sensors or occupancy determiner measuring the presence of vehicles, a comparing module compares the current occupancy to the target occupancy, and then adjusts the parking pricing to regulate the demand, so that the occupancy converges to its target. A discrete choice model may be used to model the parking decision.

### BRIEF DESCRIPTION OF THE DRAWINGS

FIG. 1 shows an occupancy feedback control.

FIG. 2 shows a diagram of a parking process modeling and control.

FIG. 3 shows a PID occupancy control simulation.

FIG. 4 shows a robustness test with different day/location for a processor based controller.

FIG. 5 shows an example of a parking price system with an occupancy feedback loop.

FIG. 6 is a flow chart illustrating an exemplary method of occupancy feedback control.

FIG. 7 is a flow chart illustrating an exemplary method of parking process modeling and control.

FIG. 8 shows an example of a system configured for parking garage and street level parking.

### DETAILED DESCRIPTION

A parking price system with market based pricing balances the varying demand for parking with the fixed supply of parking spaces. The price of parking will be higher when demand is higher, and this higher price will encourage rapid parking turnover. On the other hand, the price is too high if more than a certain number of spaces are vacant, and the price would be considered too low if no spaces are vacant. When a desired number of vacant spaces are available in a parking space area, the prices are considered optimal. For example, if prices are set to yield one or two vacant spaces for every block in a certain area, drivers can see that parking is readily available. Depending on the parking space area, to have one or two vacant spaces for every block in a parking space are the target occupancy level may vary. In one embodiment, the target occupancy level may range from 80%-90% occupancy and optimally at 85% occupancy. With the market based pricing, parking such as curb, street, and garage parking will perform efficiently. The parking spaces will be well used but readily available. And the transportation system will perform efficiently. Circling for open parking will not congest traffic, waste fuel, and pollute the air.

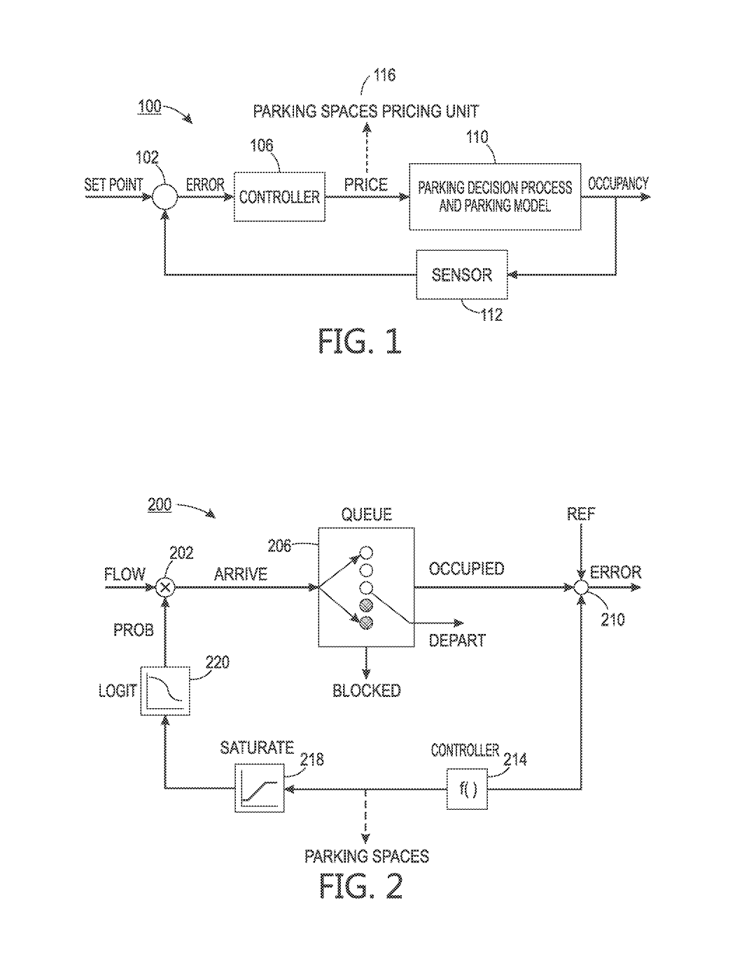

FIG. 1 is a block diagram of a system 100 configured to implement a parking pricing system using an occupancy feedback control approach of the present application. System 100 includes a comparing module 102, a processor based controller 106, a parking decision process and parking model module 110, and an occupancy determiner such as a sensor 112. In system 100, the comparing module 102 compares a set point (“Set Point”) of the target occupancy rate and the measurement data of real-time occupancy information signal from sensor 112 to determine an output (“Error”). This output being the difference between the set point and the real-time occupancy measurement. Various sensing technology can be used to measure the occupancy. For instance, parking spaces may have wireless sensors embedded in the pavement. Alternatively parking garages may have sensors at the entrance and exit gates to track the total number of cars in the garage. The real-time occupancy information signal may also include an arrival rate, departure rate, current occupancy level of a parking space, and an indication if all of the parking spaces are occupied.

The processor based controller 106 receives the output (“ERROR”) information from the comparing module 102 and determines if an adjustment for the parking price is needed, which in turn will affect parking decisions. When the measured occupancy is lower than the set point, a lower price is offered to attract more parking. When the measured occupancy is higher than the set point, a higher price is used to discourage congestion. Various control methods can be utilized for this purpose, such as PID control, on/off control, proportional control, robust and optimal control, among others. In one embodiment, the processor based controller 106 is a PID processor based controller, wherein the integral action of the PID can eliminate potential steady state errors.

In an embodiment a parking space pricing unit 116 receives the adjusted parking price from the processor based controller 106 and adjusts the parking space prices accordingly. The parking decision process and parking model module 110 stores the historical occupancy data and assumed decision models (i.e., expected number of parkers for a certain time period, such as holidays etc.). The parking decision process and parking model module 110 collects the adjusted parking space price from the processor based controller 106 and simulates the decision model based on the adjusted parking price. The parking decision process and parking model module 110 iteratively updates the models based on the newly adjusted parking price. The parking decision process and parking model module 110 outputs the occupancy measure based at least on one of the decision models, adjusted parking price, and the real-time occupancy measurements. The sensor 112 also receives the occupancy being measured. In one embodiment the sensor 112 cleans and filters the received occupancy measurements before the comparing module 102 receives the real-time occupancy measurement.

As shown in FIG. 2, the parking decision process may be modeled with a discrete choice model 200. The discrete choice model 200 includes a probability determiner 202, a queue system arrangement 206, a measuring module 210, a processor based controller 214, a saturate module 218 and a logit model module 220. The logit model 220 is used to relate the parking space price with the probability a driver will choose to park. The probability determiner 202 compares the flow of demand, such as how many drivers want to enter the system, against the probability a driver will choose to park. The parking space demand may be estimated from the historic occupancy data and classic statistic models. Demand (vehicles searching for parking) is a Poisson process with a time varying arrival rate.

In one embodiment, the real-time parking space occupancy is modeled with a storage device/queue 206, such as an M/M/1 queue, for storing information such as a measuring information signal. The storage device/queue 206 may store information such as a previous measuring information signal, present occupancy level, and estimated future occupancy level. The queue 206 maintains the number of parking space occupied by measuring the real-time occupancy of parking spaces and determines if a parking area is completely full, if a driver decides to depart from the parking area, or if the driver parks in a parking spot. The queue 206 is a system having a single server, where arrivals are determined by a Poisson process and parking times have an exponential distribution.

The measuring module 210 receives the real-time occupancy information from the queue 206 and compares the target occupancy level against the real-time occupancy information to determine the measuring information signal (error rate), the difference between the real-time occupancy information and a reference set point. For a stable control environment, the error goes to zero. The processor based controller 214 receives the measuring information signal, calculates an adjusted parking space price, and outputs the adjusted parking price.

The saturate module 218 then determines if the adjusted parking price is within a required range for parking space prices. The required range for parking space prices may be subject restrictions such as to price caps, price steps and rate constraints. The restrictions on the rate may include an occupancy rate restriction, a parking space price change rate restriction, and a parking space price cap. In some embodiments, hysteresis may be introduced to prevent price chattering.

With continuing attention to FIG. 2, the logit model module 220 then iteratively determines the probability of how many drivers will park at the current parking prices and updates the probability determiner 202.

Parking price setting is a sensitive issue that has to be handled with caution. People get confused when price changes too often or too dramatically. In the control design, explicit constraints on the pricing changes can include:
(i) an upper bound and lower bound price;
(ii) price change step size;
(iii) price change interval; and
(iv) parking duration is assumed to be a gamma distribution.

To further reduce the number of price updates, hysteresis may be introduced to the occupancy control. For example, when occupancy is increasing, the price may be held by the system until the occupancy pass a certain capacity (e.g., 90%), or when the occupancy is decreasing, the price is held until occupancy crosses a lower capacity value (e.g., 80%).

In summary, in one embodiment a control algorithm will do the following calculations to update the price at each sampling step:
(i) price=PID(delta_occcupancy); % price depends on the delta occupancy,
(ii) adjusted price=constraints(price); % price change subject to constraints and hysteresis,
(iii) occup=occup+park−departure; % (#park-#leave) is the change in occupancy,
(iv) delta_occupancy=setpoint−occupancy; % feedback the measured occupancy;
(v) prob=logit(price); % drivers' decision depends on the price; and
(vi) park=demand*prob; % realized parking is some percentage of the total demand.

Below is an exemplary control algorithm that may be used by the processor based controller 214 to update the price at each sampling step:

$$u ( n ) = {K}_{p} e ( n ) + {K}_{i} {\sum }_{k = 0}^{n} e ( k ) + {K}_{d} ( e ( n ) - e ( n - 1 ) )$$

where,
u(n) is the adjusted price;
e(n) is the delta_occupancy;
Kp is the proportional gain;
Ki is in the integral gain; and
Kd is the derivative gain.

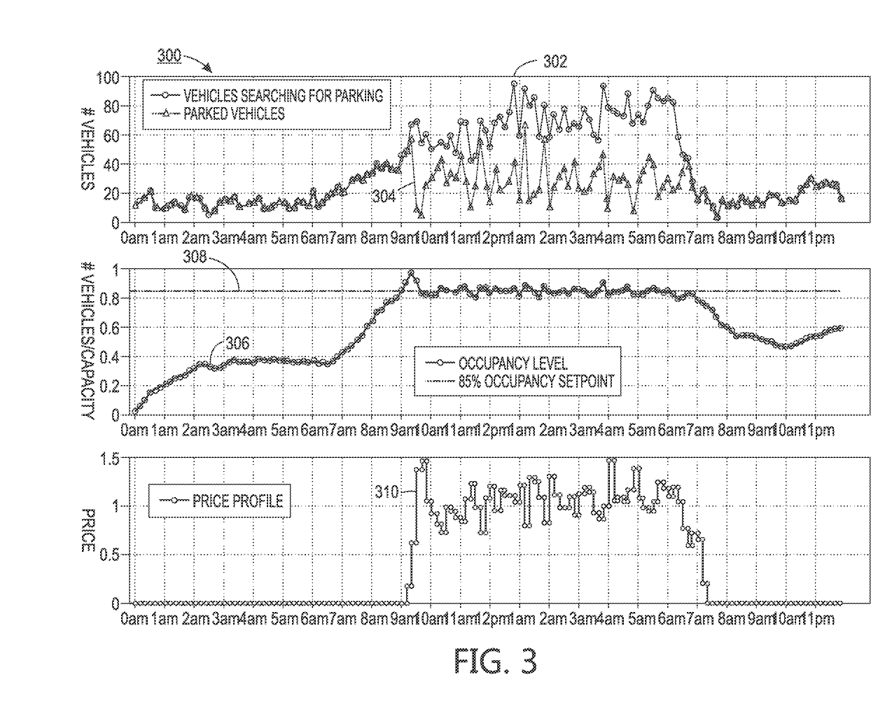

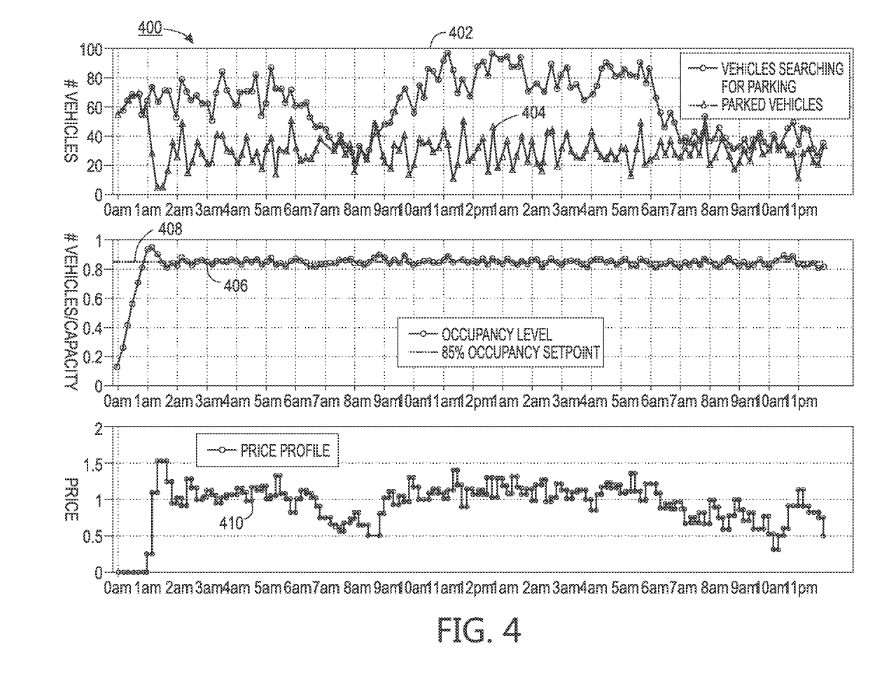

Turning to FIG. 3 illustrated are simulation results of a system according to the present application employing PID occupancy control. The top graph 300 illustrates a comparison of vehicles searching for parking and the vehicles that actually park, where curve 302 is the demand curve (i.e., vehicles searching for parking), and curve 304 represents parked vehicles (and more explicitly the realized parking at the price represented by curve 310 ), curve 306 represents occupancy level of available spaces, where line 308 represents 85% occupancy, and curve 310 is the price profile over time. Curve 306 of the middle graph depicts the occupancy level being controlled to 85% when the demand is high. The middle graph therefore shows the use of a PID control giving good output performance. In this simulation the price updates every 15 minutes. When applying the same processor based controller to a different demand curve (i.e., a different day/location, but same controller), as in the graphs 400 of FIG. 4, the control performance remains at a good output performance level, based on the results shown by curve 402, curve 404, curve 406, line 408, and curve 410, which correspond to the curves and line of FIG. 3. FIGS. 3 and 4 confirm the robustness of a PID processor based controller.

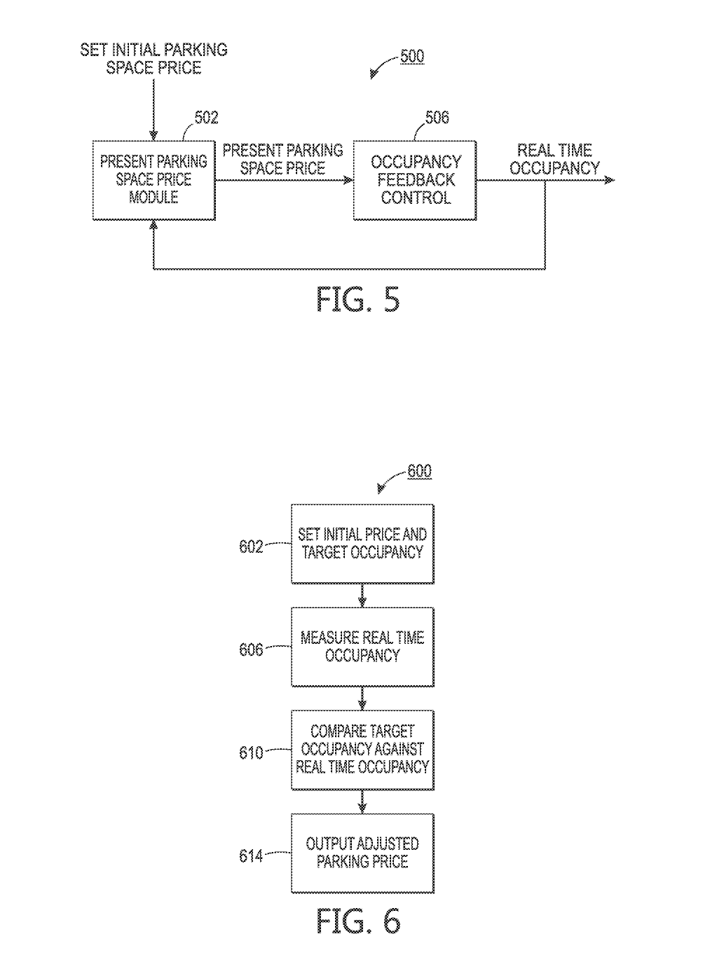

FIG. 5 is an alternative block diagram of a system 500 configured to implement the parking pricing system of the present application. As shown in FIG. 5, system 500 includes a present parking price module 502 and an occupancy feedback processor based controller 506. In system 500, an initial parking space price is set. The present parking price module 502 receives the initial parking space price and determines the present parking price. The occupancy feedback control 506 receives the present parking price and determines the real-time occupancy level for a parking space area. The present parking price module 502 then receives the real-time occupancy level from the occupancy feedback control 506 for the parking space area and iteratively determines how to adjust the parking space price. In one embodiment, the present parking price module 502 determines how much to adjust the parking price based on at least one of a mode, historical data, the projected occupancy level, parking space price caps, a price stepping function, and/or parking price rate constraints.

### Example Methods for Determining the Adjusted Parking Price

System 100 and system 200 shown in FIGS. 1 and 2 may be configured to generate the projected occupancy level of a parking space area in various ways and using various methods. For instance, in an embodiment, system 100 may operate according to a method shown by flowchart 600 of FIG. 6 for determining the adjusted parking price.

Flowchart 600 begins with step 602. In step 602, the initial parking space price is set and the target occupancy level is determined. In step 606, the real-time occupancy level of a parking space area is determined. For example, in an embodiment, sensor 112 (FIG. 1) may determine the real-time occupancy of a parking space area. In step 610, the target occupancy level is compared against the real-time occupancy level. In one embodiment, comparing module 102 (FIG. 1) may determine the error by comparing the target occupancy level against the real-time occupancy level. In step 614, any adjustments to the initial parking space price are determined and an adjusted parking price is output. For example, in an embodiment, the processor based controller 106 may determine and output any adjustments to the initial parking space price. If the parking space price is adjusted it may be output to devices such as street parking space meters or garage parking space indicators. In step 614, the adjusted parking price may be iteratively output to step 606 to determine the effect of an adjusted parking space price on the real-time occupancy of a parking space area.

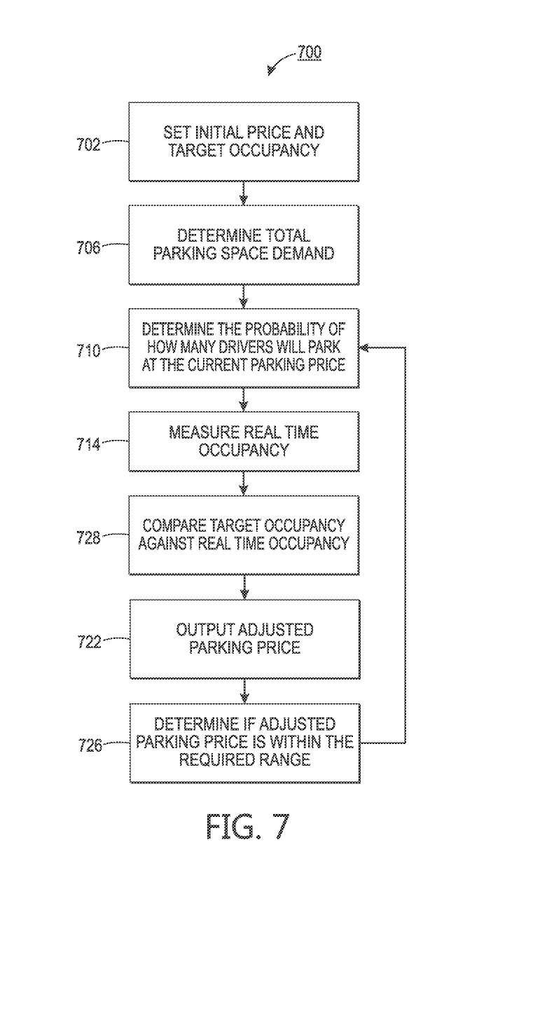

Flowchart 700 of FIG. 7 depicts a simulation that compiles the data, models, and information for implementation in a parking space environment. In step 702, the initial parking space price is set and the target occupancy level is determined. In step 706, the total parking space demand of a parking space area is determined. In step 710, the probability of how many drivers will park for the current parking price is determined. For example, in an embodiment, probability determiner 202 (FIG. 2), may determine the probability of how many drivers will park at the current parking price. In step 714, the real-time occupancy level of a parking space area is determined. For example, in an embodiment, queue 206 (FIG. 2) may determine the real-time occupancy of a parking space area. In step 718, the target occupancy level is compared against the real-time occupancy level. For example, in an embodiment, measuring module 210 (FIG. 2) may determine the error by comparing the target occupancy level against the real-time occupancy level. In step 722, any adjustments to the initial parking space price are determined and an adjusted parking space price is output. If the parking space price is adjusted, it may be output to devices such as street parking space meters or garage parking space indicators. For example, in an embodiment, processor based controller 214 may determine and output any adjustments to the initial parking space price. In step 726, it is determined if the adjusted parking price is within a required range. For example, in an embodiment, the saturate module 218 (FIG. 2) may determine if the adjusted parking price is within the required range. In step 726, the adjusted parking price may be iteratively output to step 710 to determine the effect of an adjusted parking space price on the real-time demand for parking spaces.

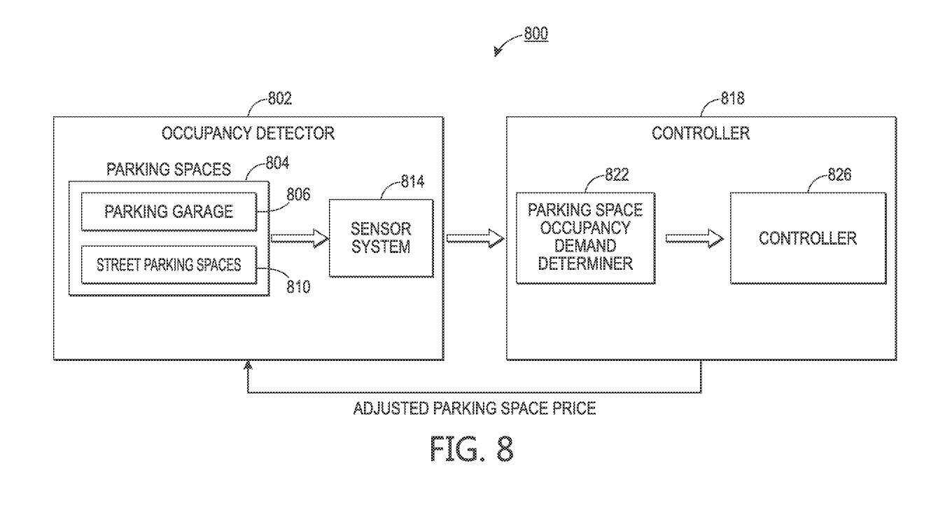

FIG. 8 shows a block diagram overview of a system 800 configured to implement the parking pricing system for parking spaces. As shown in FIG. 8, system 800 includes an occupancy detector 802 and a processor based controller 818. The occupancy detector 802 monitors parking spaces 804 that are available for drivers to park a vehicle and a sensor system 814. The parking spaces 804 may include parking garage spaces 806, street level parking spaces 810, or a combination thereof. The parking spaces 804 are monitored for occupancy by sensor system 814. In one embodiment, the sensor system 814 includes wireless sensors embedded in the pavement, motion sensors, optical detectors, and/or radio transceiver sensors. Additionally, parking garages may have sensors at the entrance and/or exit gates to track the total number of cars in the garage.

The processor based controller 818 may further include parking space occupancy demand determiner 822 and a processor based controller 826. In one embodiment, the processor based controller 826 is a PID controller, although of course other controllers may be used. The processor based controller 818 receives the real-time occupancy information from the occupancy detector 802 and the parking space occupancy demand determiner 822 determines the real-time demand for the parking spaces 802. The processor based controller 826 receives the occupancy demand signal or information from parking space occupancy demand determiner 822 and adjusts the parking space prices based on the real-time demand information and/or historical models of the demand for parking spaces 802. The processor based controller 822 iteratively updates the models based on the new adjusted parking price. If the adjusted prices changes, the occupancy detector 802 receives the adjusted parking space price from the processor based controller 818 and may update the present parking spaces prices accordingly.

Embodiments of the present application have been shown to relate to a parking price system that implements market based parking pricing from an occupancy feedback control approach. One embodiment has described the target occupancy level is about 85% capacity, where the parking price system measures the current parking space occupancy and then uses a processor based controller to automatically set variable parking space prices that correspond with the real-time demand rates to achieve the target occupancy level of 85% capacity. However, it is to be appreciates the target occupancy level may vary depending on the size of the parking area, the location of the parking area, or the density of parking spaces.

Parking demand is variable over time and location. Therefore, the parking price system is configured to group times such as days with similar demand or qualities as one mode, then deal with each mode separately. For instance, all weekdays are defined as one mode, and a weekend as another mode. In another instance specific days or times such as holidays, night-time, lunch-time, and special events are defined as modes. For the same mode, the demand varies within a narrow range. This allows one or more processor based controller to address these variations as these modes are implemented in the pricing scheme.

Various control methods can be used for the parking price system. In one embodiment a proportional—integral—derivative (PID) processor based controller has been discussed as a feedback processor based controller for the control method. The PID processor based controller calculates an error value as the difference between a measured process variable and a desired set point. The processor based controller attempts to minimize the error by adjusting the process control inputs.

The PID processor based controller calculation involves three separate constant parameters: the proportional, the integral and derivative values, denoted P, I, and D. Heuristically, for the PID processor based controller the P, I, and D parameters can be interpreted in terms of time where P depends on the present error, I on the accumulation of past errors, and D is a prediction of future errors, based on current rate of change. Where D is sensitive to the measurement noise, the D gain may be set to 0. In an embodiment focused on the steady state error, an integral control may be used.

The PID processor based controller may be tuned using the three P, I, and D parameters in the PID processor based controller to provide control action for specific process requirements. The response of the processor based controller can be described in terms of the responsiveness of the processor based controller to an error, the degree to which the processor based controller overshoots the set point, and the degree of system oscillation

Some embodiments may use only one or two parameters to provide the appropriate system control. Using only one or two parameters can be achieved by setting the other parameters to zero. A PID processor based controller may be called a PI, PD, P or I processor based controller in the absence of the respective control actions. A PI processor based controller may be used because the derivative action is sensitive to measurement noise. A PD processor based controller may be used to prevent the system from exceeding its target value. The PID processor based controller may further be tuned using control loop to adjustment control parameters, such as proportional band or gain, integral gain or reset, and derivative gain or rate, to the optimum values for the desired control response.

In another embodiment, a proportional-integral (PI) processor based controller is used. The tuning objective of the PI processor based controller is to find a trade-off between output performance and price profile smoothness. Output performance includes the rise time, overshoot, and steady state error. Tuning may begin with either the P control or I control, then tuning the gains and determining the desired performance results. Manually tuning the processor based controller to achieve an acceptable trade-off may be used or alternatively generating an optimization problem to include the input constraints.

Various models can be used for the parking price system to relate parking pricing to choice probability. In one embodiment a logit model is used to relate the parking price to the choice probability. A logit model is a statistical model that describes the relationship between a qualitative dependent variable that can take only certain discrete values and an independent variable. In one embodiment, the dependent variable measures the likelihood to of a driver's willingness to park in a parking space. The dependent variable may be equal to 1 if the driver parks in the parking space and 0 otherwise. The logit model is used to estimate the factors which influence parking behavior. The logit model may use a logistic distribution, such as a cumulative distribution function with an S-shaped pattern and a quantile function. The logit model may also use a binomial or multinomial logistical regression.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A parking price system for adjusting parking prices, comprising:
an occupancy determiner for determining the occupancy of an parking area, wherein the occupancy determiner includes at least one sensing device, and the occupancy determiner outputting an occupancy information signal; and
a controller that receives the occupancy information signal and is configured to adjust at least one parking space price for at least one parking space, wherein the controller is configured to determine from the received occupancy information signal an optimal parking space price for the at least one parking space based on the occupancy information signal, wherein the system employs at least one processor.

2. The parking price system of claim 1, wherein the controller is a proportional—integral—derivative (PID) processor based controller.

3. The parking price system of claim 1, wherein the occupancy determiner further comprises a comparing module configured to determine the difference between a real-time occupancy measurement from the sensor and a target occupancy set point, and to include an indication in the occupancy information signal of the difference between the real-time occupancy measurement from the sensor and the target occupancy set point.

4. The parking price system of claim 1, wherein the processor based controller further comprises a parking decision process and parking model module configured to store historical occupancy data and simulate a decision model based on at least on one of the adjusted parking space price and the historical occupancy data.

5. The parking price system of claim 1, wherein the optimal parking space price occurs when an occupancy level of the area is about 80% to 90% of full occupancy.

6. The parking price system of claim 1, wherein the controller is further configured to group times with a similar occupancy information as parking space price modes.

7. The parking price system of claim 6, wherein the parking space price modes comprises at least one of a weekend mode, a weekday mode, a holiday mode, a night mode, and a special event mode.

8. The parking price system of claim 1, wherein the at least one sensing device is at least one of a wireless sensor embedded into the pavement, an entrance gate sensor, and an exit gate sensor.

9. A parking price system for adjusting parking prices, comprising:
a parking space occupancy demand determiner for determining the demand for at least one parking space of an area, and the parking space occupancy demand determiner outputting a parking space demand signal;
a probability determiner determines the probability of at least one parking space price being occupied based at least in part on the parking space demand signal;
the occupancy determiner for determining the real-time occupancy of an area, wherein the occupancy determiner includes at least one sensing device, and the occupancy determiner outputs a real-time occupancy information signal;
a measuring module configured to determine the difference between a real-time occupancy measurement from the occupancy determiner and a target occupancy set point, and outputting a measuring information signal of the difference between a set point of a real-time occupancy measurement from the occupancy determiner and the target occupancy set point; and
a processor based controller configured to automatically adjusting at least one parking space price based on a target occupancy level, wherein the processor based controller is configured to determine from the received measuring information signal an optimal parking space price for at least one parking space.

10. The parking price system of claim 9, wherein the processor based controller further comprises restrictions on the optimal parking space price including at least one of an occupancy rate restriction, a parking space price change rate restriction, and a parking space price cap.

11. The parking price system of claim 9, wherein the occupancy determiner further comprises a storage device for storing the measuring information signal.

12. The parking price system of claim 11, wherein the storage device is an M/M/1 queue.

13. The parking price system of claim 11, wherein the storage device stores at least one of a previous measuring information signal, present occupancy level, and estimated future occupancy level.

14. The parking price system of claim 9, wherein the controller is configured to adjust the optimal parking space price using a step function.

15. The parking price system of claim 9, wherein the real-time occupancy information signal further includes at least one of an arrival rate, departure rate, current occupancy level of the at least one parking space, and an indication if all of the at least one parking space is occupied.

16. The parking price system of claim 9, wherein the processor based controller further comprises a logit model that relates the optimal parking space price to a choice probability.

17. A method for adjusting parking space prices, the method comprising:
setting an initial parking space price and a target occupancy level for a parking space area;
measuring the real-time occupancy level of a parking space area;
generating parking space occupancy information based on the real-time occupancy level and a target occupancy level; and
setting an adjusted parking space price based on the parking space occupancy information for the at least parking space.

18. The method as in claim 17, further comprising:
measuring the real-time occupancy level by monitoring at least one parking space in the parking space area;
determining from the monitoring the demand for the at least on parking space; and
determining the probability of the at least on parking space being occupied based on the adjusted parking price.

19. The method as in claim 17, further comprising:
determining if the adjusted parking space price is within a required range.

20. The method as in claim 17, further comprising:
iteratively updating a parking space meter price based on the adjusted parking space price.
